(19) United States
(12) Patent Application Publication
(10) Pub. No.: US 2020/0101335 A1
(43) Pub. Date: Apr. 2, 2020

(54) SYSTEM AND METHOD FOR BATTERY FIRE EXTINGUISHING THROUGH FLOODING THE BATTERY

(71) Applicant: Union Storage Energy System LTD., New Taipei City (TW)

(72) Inventors: CHIH-PENG LIU, New Taipei City (TW); JUI-HSING TSAI, New Taipei City (TW); MING-HUEI TSAI, New Taipei City (TW)

(21) Appl. No.: 16/377,906

(22) Filed: Apr. 8, 2019

(30) Foreign Application Priority Data
Oct. 1, 2018 (TW) 107134579

(51) Int. Cl. A62C 3/16; H01M 10/42; A62C 37/40

(52) U.S. Cl. CPC A62C 3/16; H01M 10/42; H01M 2220/20; H01M 2200/00; A62C 37/40

(57) ABSTRACT

A system and method for battery fire extinguishing through flooding the battery are disclosed. The method mainly comprises the steps of: providing a battery box for a battery and a water solution container, the water solution container is injected into a water solution; detecting a fire state of the battery; and flooding the water solution into the battery box to extinguishing the fire when the battery is on fire.

### BACKGROUND OF THE INVENTION

### 1. Field of the Invention

The present invention relates to a battery fire extinguishing system, and more particularly to a system and method for battery fire extinguishing through flooding the battery.

### 2. Description of the Related Art

Electric vehicles, or energy storage equipment, etc., all use batteries as an energy storage and a power source. Since the power source of the electric vehicle is the battery, no matter which kind of electric vehicle, such as BEV (pure Battery Electric Vehicles), HEV (Hybrid Electric Vehicles), PHEV (Plug-in Hybrid Electric Vehicles) and REEV (Range-Extended Electric Vehicles), fuel cell vehicles, or solar vehicles, etc., all need a battery to be able to provide a large current for the power of vehicles conversion. At present, high-current batteries are dominated by high-energy-density batteries, for example, lithium-ion batteries, which have high energy density characteristics, and are also batteries in which an organic solution is used as an electrolyte.

However, the accidents of the fire and explosion of lithium-ion batteries and the post-collision combustion events have also cast a shadow have come in for serious criticism on the safety issues of lithium-ion high-energy-density batteries. The misfire characteristic of the lithium-ion battery The worst is that even if the external flame has been extinguished due to the fire and explosion of lithium-ion batteries, the serious chemical reaction of the internal inside the batteries still continues, and therefore, secondary often induces second combustion often occurs. So far, there is no specific effective fire extinguishing system that can support the fire extinguishing of high-energy-density batteries like lithium-ion batteries, and even prevent secondary second combustion.

Therefore, how to developing a new fire extinguishing system for batteries fire and that preventing its their secondary combustion when the battery burns immediately after the combustion (whether due to collision, internal short circuit, thermal runaway, etc.), has become an important development direction for the development of battery fire extinguishing systems.

### BRIEF SUMMARY OF THE INVENTION

In view of the above, the present invention provides a system and method for battery fire extinguishing through flooding the battery. The system utilizes a closed battery space and provides a fire extinguishing system mainly composed of a water solution, and when the burning or fire state of the battery is detected, the battery is extinguished after by the water solution is filled with filling the battery space. In this way, the disaster can be locked into within the battery space at the first time point of the disaster, thereby reducing the disaster property loss and preventing the special technical effect decreasing the possibility of secondary combustion of the battery.

The present invention discloses a system for battery fire extinguishing through flooding the battery, comprising: at least one water solution container, used for accommodating a water solution; at least one battery box, each of the battery boxes having a battery space for accommodating at least one battery; a water distribution pipe, connected to the water solution container and the at least one battery box, and arranged at least one water outlet in the body of each of the battery box; and at least one water outlet control gate, one water outlet control gate provided at the water outlet, wherein the water is discharged from the water outlet when the battery is burning burned, so that the water solution floods the battery in the battery box to extinguish the fire.

The present invention also discloses a method for battery fire extinguishing through flooding the battery, comprising the following steps of: providing a battery box required for a battery and a water solution container, the water solution container is injected into a water solution; detecting a fire state of the battery; and flooding the battery in the battery box by the water solution in from the water solution container to extinguish fire when the battery in the battery box is in the fire state.

The detailed features and advantages of the present invention are described in detail in the following description of the embodiments of the present invention. The related objects and advantages of the present invention will be readily understood by those skilled in the art.

### BRIEF DESCRIPTION OF THE DRAWINGS

FIG. 1 is a flow chart of a method for battery fire extinguishing through flooding the battery of the present invention.

FIG. 2A-2C is a system architecture diagram, a cross-sectional view and a top view of a first embodiment of the system for battery fire extinguishing through flooding the battery of the present invention.

FIG. 3A-3C is a system architecture diagram, a cross-sectional view, and a bottom view of a second embodiment of the system for battery fire extinguishing through flooding the battery of the present invention.

FIG. 4A-4D are system architecture, cross-sectional view, a top view and a bottom view of a third embodiment of the system for battery fire extinguishing through flooding the battery of the present invention.

FIG. 5A-5C are system architecture, cross-sectional and bottom views of a fourth embodiment of the system for battery fire extinguishing through flooding the battery of the present invention.

### DETAILED DESCRIPTION OF THE INVENTION

In the present invention, a flooding type is used to allow the water solution to flood a battery (for example, a high-density organic battery such as a lithium ion battery) to achieve active automatic fire extinguishing when the battery is on fire fired. Further, since the battery box in which the battery is placed has been filled with the water solution to flood the battery, the battery in the battery box is immediately cooled down to extinguish the fire and reduce the internal chemical reaction rate of the battery. Moreover, since the battery has been isolated from the outside via the water solution, the battery does not contact the air, thereby blocking the supply of oxygen, further blocking the possibility of further combustion of the battery. In addition, the battery can be discharged by the other electrolyte in the water solution to release the battery electricity energy and decrease temperature of the battery, and the possibility of secondary spontaneous combustion of the battery is further prevented. Therefore, with the battery fire extinguishing system through flooding the battery of the present invention, it is possible to constrain the achieve a reduction or of battery fire damage isolated in to the battery box in which a fire event occurs without further spreading to other battery boxes.

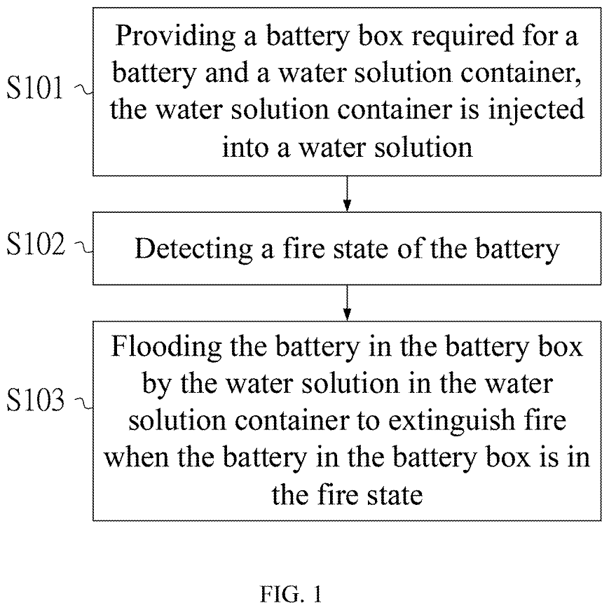

Please referring to FIG. 1, it is a flow chart of a method for battery fire extinguishing through flooding the battery of the present invention. The method comprises the following steps of:

Step 101: providing a battery box required for a battery and a water solution container, the water solution container is pre-stuffed-injected into with a water solution. The water solution is selected from the group consisting of tap water, sodium chloride (NaCl) solution, sodium hydroxide (NaOH) solution, and sodium sulfate (NaSO₄) solution. The weight percentage of electrolyte of the sodium chloride (NaCl) solution, the sodium hydroxide (NaOH) solution, and the sodium sulfate (NaSO₄) solution ranges from 0.2% to 26%. Alternatively, the weight percentage of electrolyte of each solution is between 0.2% and 20%; or, the weight percentage of electrolyte of each solution is between 10% and 20%.

The use of different electrolyte solutions such as sodium chloride (NaCl) solution, sodium hydroxide (NaOH) solution, sodium sulfate (NaSO₄) solution, etc., can effectively discharge the lithium ion in the lithium ion battery to release battery electricity energy.

Step 102: detecting a fire state of the battery. Wherein, the step of detecting the fire state of the battery is sensed performed by sensing a heat sensing mode of a sealed automatic-sprinkler, and interlocking the water solution in the water solution container to fill the battery box. The heat sensitive automatic sprinkling temperature of the sealed automatic-sprinkler is set between 60° C. and 150° C.

Alternatively, the step of detecting the fire state of the battery is sensed performed by sensing a fire sensor, and then switching an unsealed sprinkler using a control host to control an electromagnetic valve to interlock the water solution in the water solution container to fill the battery box.

Step 103: flooding the battery in the battery box by the water solution in the water solution container to extinguish fire when the battery in the battery box is in the fire state.

As described above, when the water solution containing the electrolyte floods the battery in the battery box, the temperature of the battery can be immediately lowered and the chemical reaction rate inside the battery can be also decrease lowered, and the fire extinguishing can be directly performed. Second, since the battery is flooded in the water solution, it is isolated from the outside air, thereby isolating the oxygen, thereby reducing avoiding the possibility of further combustion. Third, the electrolyte in the water solution can discharge the battery and release electricity energy of the burning battery, further reducing the possibility of burning the battery again.

Moreover, the method further comprises the step of: pressurizing the water solution in the water solution container, so that the water solution can accelerate the filling rate of the corresponding battery box. The method of pressurizing the water solution here can be carried out by pressing a heavy object pressing method, that is, a heavy object is placed above the water solution container, and the weight is pressed down. Alternatively, a high pressure method is employed, that is, the water solution container is placed at a high position. Alternatively, a motor water pump is added for pressurizing the water solution or the like. In addition, there are many other pressurization techniques, which are not enumerated in detail herein.

As described above, the technique of flooding the battery in the battery box is presented. First, a system for supplying a water solution, that is, a water storage device (that is, a water solution container) and a corresponding water distribution pipe are provided. Secondly, it is necessary to provide a mechanism for detecting the burning or fire state of the battery. As mentioned above, a sealed automatic-sprinkler or a fire sensor can be used. Thirdly, in the case of battery burning or firing, a water solution is provided immediately, and the burning battery is flooded. If the water solution can use a sodium-based electrolyte, the discharge rate of the battery can be accelerated. Hereinafter, a plurality of specific embodiments will be described to explain the battery fire extinguishing system through flooding the battery of the present invention.

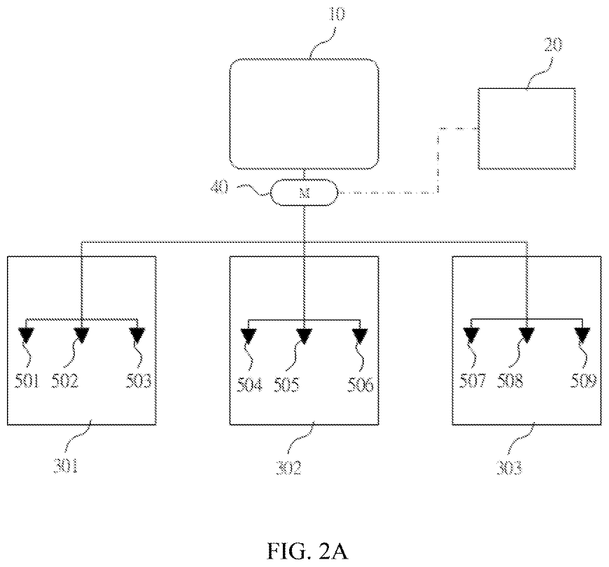

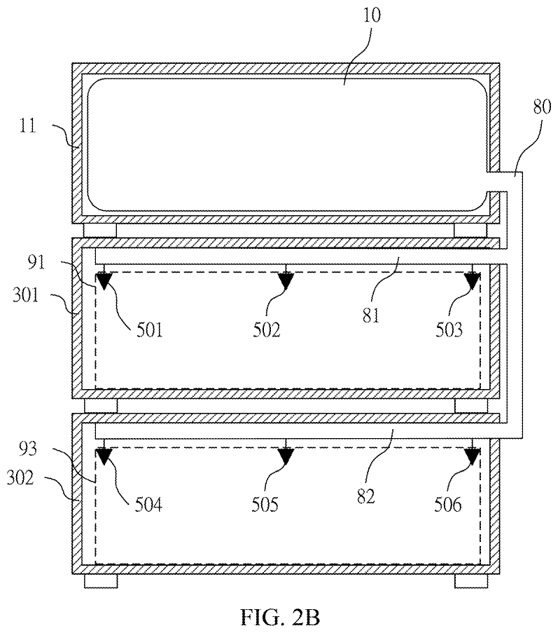

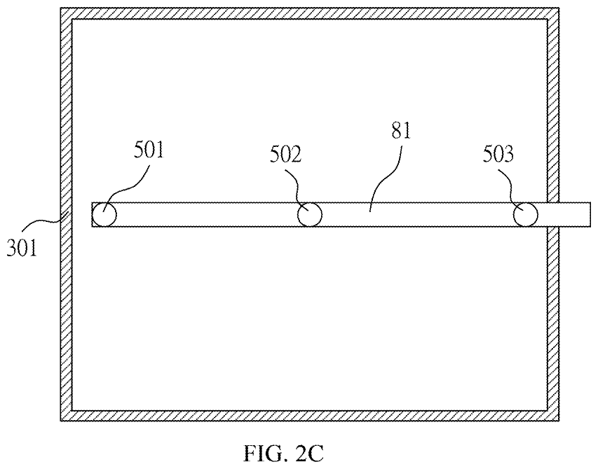

Next, referring to FIG. 2A-2C, the first embodiment of the battery fire extinguishing system through flooding the battery of the present invention comprises: a water tank (a water solution container having a water tank wall 11) 10, a control host 20, the battery box 301, the battery box 302, the water distribution pipe 80, the water distribution pipe 81, the water distribution pipe 82, the water outlet control gates 501-506, and the like, and the pressurizing device 40. The battery boxes 301 and 302 each have a battery space for accommodating at least one battery. In this embodiment, two batteries can be accommodated. The water distribution pipe 80 is connected to the water tank 10 (water solution container) and the battery boxes 301 and 302, and at least one water outlet is disposed in the battery boxes 301 and 302 (via the water distribution pipes 81 and 82, respectively). The water outlet control gates 501-506 are provided with a water outlet control gate at the water outlet, and water is discharged when the batteries 91 and 93 are burned or fired, so that the water solution floods the batteries 91 and 93 in the battery boxes 301 and 302 to extinguish the fire. In this embodiment, each of the battery boxes 301, 302 is configured with three water outlets and three water outlet control gates (501-503, 504-506).

In this embodiment, a sealed automatic-sprinkler is used as the water outlet control gates 501-506. The temperature of the sealed automatic-sprinkler can be is set between 60° C. and 150° C. In other words, as soon as the set automatic sprinkling temperature is reached, the sealed automatic-sprinkler will burst and then automatically sprinkle water, thus making the water solution of the water solution container 10 inject into the battery box 301 or the battery box 302, so that the batteries 91, 93 and the like among the battery box 301 or the battery box 303 are flooded with the water solution, thereby achieving the aforementioned fire extinguishing effect.

In the embodiment of FIG. 2A-2C, it is an embodiment in which the outlet control gates 501-506 are disposed on the top of the battery boxes 301, 302. FIG. 2A is a system architecture diagram of the system for battery fire extinguishing through flooding the battery of the present invention. FIG. 2B is a cross-sectional view of the system for battery fire extinguishing through flooding the battery of the present invention. FIG. 2C is a top view of the system for battery fire extinguishing through flooding the battery of the present invention.

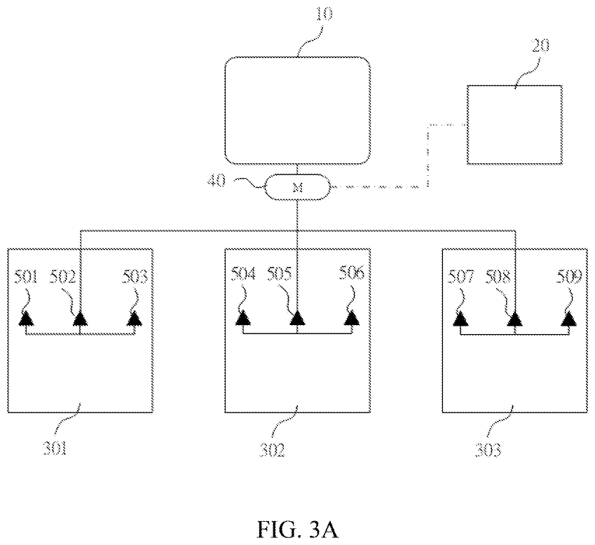

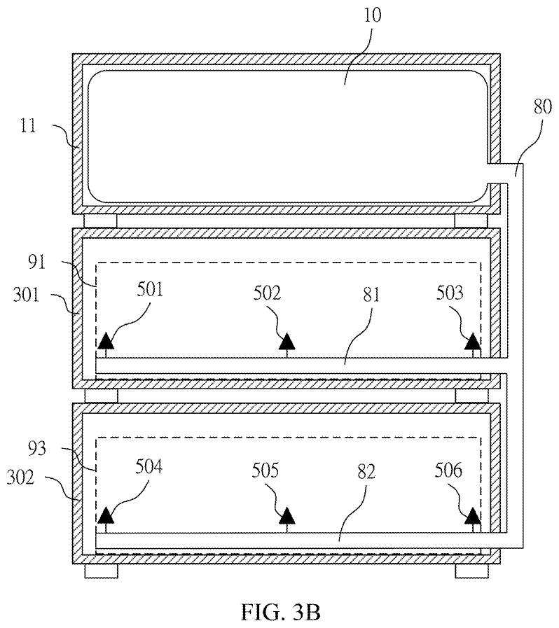

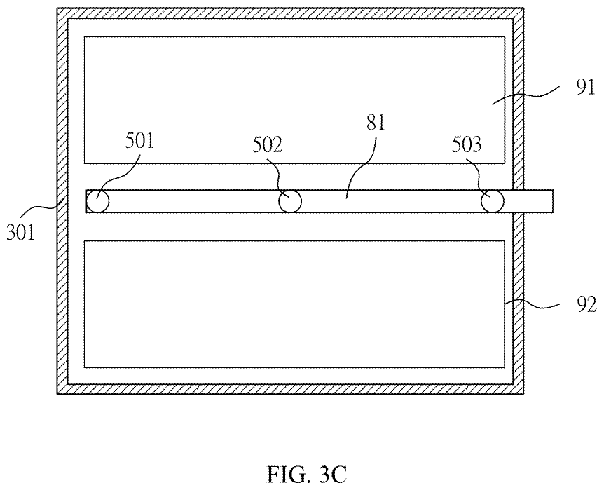

FIG. 3A-3C is a system architecture diagram, a cross-sectional view, and a bottom view of a second embodiment of the system for battery fire extinguishing through flooding the battery of the present invention. The system comprises: a water tank (water solution container) 10, a control host 20, a battery box 301, a battery box 302, a water distribution pipeline 80, a water distribution pipeline 81, a water distribution pipeline 82, water outlet control gates 501-506, and a pressurizing device 40. Unlike the embodiment of FIG. 2A-2C diagram, in the embodiment of FIG. 3A-3C diagram, the water outlet control gates 501-506 are respectively disposed at the bottom of the battery boxes 301, 302. Also, a sealed automatic-sprinkler is used as the water outlet control gates 501-506. The rest of FIG. 3A-3C are the same as FIG. 2A-2C, thus there is no longer described in detail.

The embodiment of FIG. 2A-2C and the embodiment of FIG. 3A-3C show that the water outlet control gates 501-506 can be placed on the top or bottom or side of the battery compartments 301, 302 (not shown). Correspondingly, the water distribution pipes 81, 82 are also disposed on the top or bottom or side of the battery boxes 301, 302, respectively. In other words, since the object of the present invention is to flood the entire battery box with a water solution, it is possible to flood water solution from any direction position.

The sensible heat sprinkling of the A sealed automatic-sprinkler with sensible heat design can be applied without using the control host 20. The control host 20 used in the embodiment of the FIG. 2A-2C diagram and the embodiment of the FIG. 3A-3C diagram is used to control the pressurizing device 40, such as a water pump pumping motor, which automatically pressurizes to sprinkle water after while the sealed automatic-sprinkler bursts. As mentioned above, the method of pressurizing the water solution can additionally adopt a high pressure method, that is, the water solution container is placed at a high position, and gravity is used, which is the implementation of FIG. 2A-2C and FIG. 3A-3C. For example, when the water tank 10 is disposed above the battery boxes 301 and 302, the water solution in the water tank 10 can generate a higher potential energy, and the water distribution pipes 81 and 82 can be pressurized by the potential energy. In another type of pressurizing the water solution, a weight may be placed above the water solution container as the pressurizing means 40.

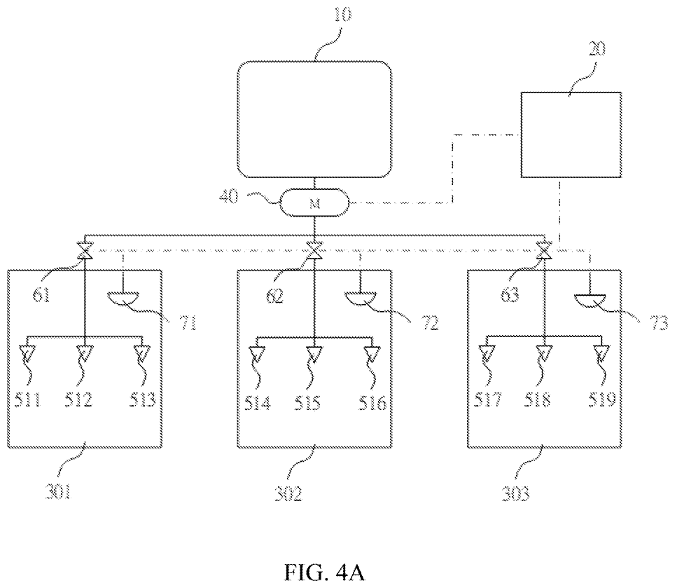

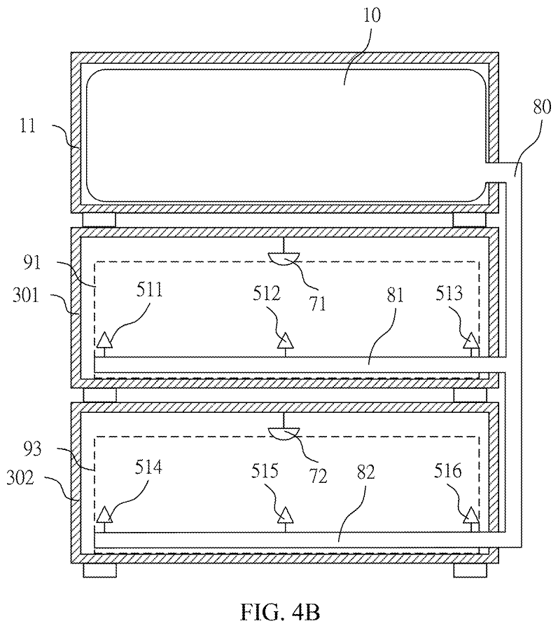

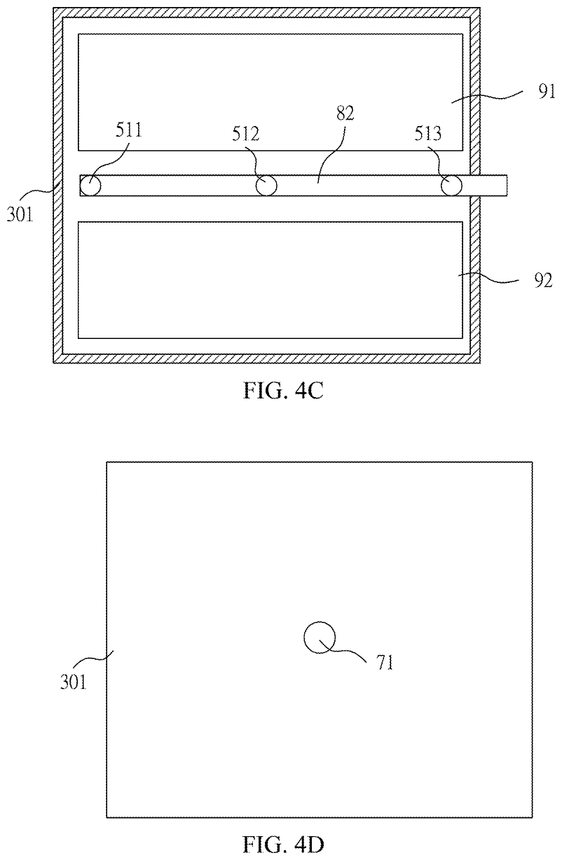

However, in addition to the fire sensing mechanism of the sensible heat water sprinkler of like the sealed automatic-sprinkler, there are many other different fire sensing mechanisms available. Referring to FIG. 4A-4D, a third embodiment of the battery fire extinguishing system through flooding the battery of the present invention comprises: a water tank (water solution container) 10, a control host 20, a battery box 301, a battery box 302, and a water distribution pipeline. 80, a water distribution line 81, a water distribution line 82, water outlet control gates 511-516, electromagnetic valves 61-62, fire sensors 71-72, etc., a pressurizing device 40. The battery boxes 301 and 302 each have a battery space for accommodating the batteries 91, 92, and 93. In this embodiment, two batteries can be accommodated. The water distribution pipe 80 is connected to the water tank 10 (water solution container) and the battery boxes 301 and 302, and at least one water outlet is disposed in the battery boxes 301 and 302 (via the water distribution pipes 81 and 82, respectively). The water outlet control gates 511-516 are provided with a water outlet control gate at the water outlet to discharge water when the batteries 91 and 93 are burning burned or on fire fired, so that the water solution floods the batteries 91 and 93 in the battery boxes 301 and 302 to extinguish the fire. In this embodiment, each of the battery boxes 301, 302 is configured with three water outlets and three water outlet control gates (511-513, 514-516).

In addition, in this embodiment, electromagnetic valves 61-62 and fire sensors 71-72 are additionally provided, and an electromagnetic valve 61 and a fire sensor 71 are respectively disposed in the battery box 301, and an electromagnetic valve 62 is disposed in the battery box 302. The fire sensors 71 and 72 are disposed in each of the battery boxes 301 and 302 to sense a fire condition and generate a fire occurrence signal. The electromagnetic valves 61 and 62 are disposed at least one outside the battery boxes 301 and 302. The electromagnetic valves 61 and 62 are connected to the water distribution pipes 80, 81 and 82. After receiving the release signal, the electromagnetic valves 61 and 62 are opened to make the water solution of the water distribution pipe 80 flow from the water tank 10 to the water outlet control gates 511-516 (unsealed sprinkler). The control host 20 is electrically connected to the fire sensors 71-72 and the electromagnetic valves 61-62. When one of the fire sensors 71-72 generates a fire occurrence signal, the corresponding electromagnetic valves 61-62 are controlled to make the water solution by the water outlet control gates 511-516 inject into the corresponding battery boxes 301,302.

The fire sensors 71, 72 are selected from a smoke sensor, a temperature sensor, a photoelectric sensor, an infrared sensor, or a current sensor. The current sensor is disposed on the batteries 91, 92, and 93. When an excessive current is generated, it is possible to determine that a fire of the battery may occur.

In this embodiment, an unsealed sprinkler is used as the water outlet control gates 511-516. The unsealed sprinkler is of an unsealed. When the electromagnetic valve 61 or 62 is released, the water solution is passed from the water tank 10 and the water distribution pipe 81 or 82 via the water outlet control gates 511-513 or the water outlet control gates 514-516. In other words, the biggest difference from FIG. 2A-2C is that the unsealed sprinkler used in the embodiment of FIG. 4A-4C is reusable. However, the sealed automatic-sprinkler is used only once, and both fire sensing mechanisms are different. However, the same place is that both mechanisms can achieve the purpose of flooding the battery of the present invention.

Similarly, in the embodiment of FIG. 4A-4D, the arrangement of the unsealed sprinklers is provided at the bottom of the battery boxes 301, 302, as shown in the top view of FIG. 4C, which is the same as the embodiment of FIG. 3A-3C. The fire sensors 71, 72 are disposed on the top of the battery boxes 301, 302 as shown in the bottom view of FIG. 4D.

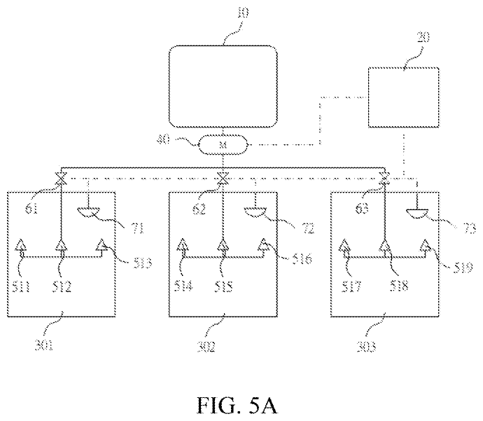

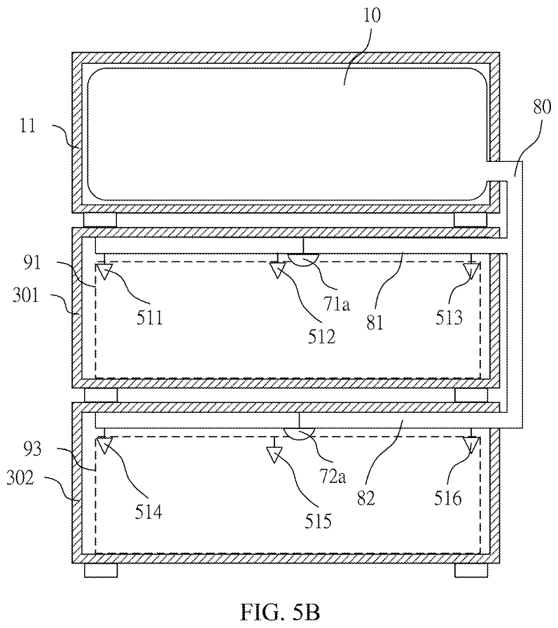

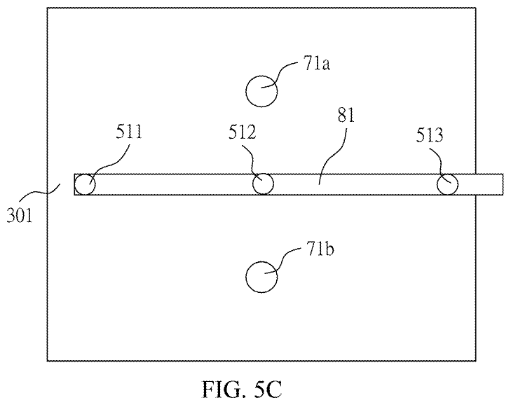

In another embodiment of the present invention, as in the embodiment of FIGS. 4A-4D, the water outlet control gates 511-516 may also be disposed on the top of the battery boxes 301, 302, as shown in the embodiment of FIG. 5A-5C. In this embodiment, two fire sensors, namely, a fire sensor 72a and another fire sensor 71b are disposed in the battery boxes 301, 302, respectively. The rest of FIG. 5A-5C are the same as the embodiment of FIG. 4A-4D, and will not be described again here.

The battery fire extinguishing system through flooding the battery of the invention can be applied to a battery energy storage system, an electric vehicle, an electric motor vehicle and the like. When used in a battery energy storage system, it is possible to pressurize the water solution container (water tank) to a higher position in a positional manner. When used in an electric vehicle or an electric motor vehicle, the backup battery and the backup motor can be used for pressurization, so that the water solution in the water solution container (water tank) can inject the water solution into the burning battery box when the battery is burned burning or on fire fired.

While the invention has been disclosed in the foregoing preferred embodiments, they are not intended to limit the present invention, and one skilled in the art, without departing from the spirit and scope of the present disclosure, may make various changes or modifications. Therefore, the scope of the present invention is best defined by the appended claims.

What is claimed is:

1. A system for battery fire extinguishing through flooding the battery, comprising:
at least one water solution container, used for accommodating a water solution;
at least one battery box, each of the battery boxes having a battery space for accommodating at least one battery;
a water distribution pipe, connected to the water solution container and the at least one battery box, and arranged at least one water outlet in the body of each of the battery box; and
at least one water outlet control gate, one water outlet control gate provided at the water outlet, wherein the water is discharged from the water outlet when the battery is burned burning or on fire, so that the water solution floods the battery in the battery box to extinguish the fire.

2. The system according to claim 1, wherein the water solution is selected from the group consisting of tap water, sodium chloride (NaCl) solution, sodium hydroxide (NaOH) solution, and sodium sulfate (NaSO₄) solution.

3. The system according to claim 2, wherein the weight percentage of electrolyte of the sodium chloride (NaCl) solution, the sodium hydroxide (NaOH) solution, and the sodium sulfate (NaSO₄) solution ranges from 0.2% to 26%.

4. The system according to claim 1, wherein the water outlet control gate is a sealed automatic-sprinkler, and the heat sensitive automatic sprinkling temperature of the sealed automatic-sprinkler is between 60° C. and 150° C.

5. The system according to claim 1, wherein the water outlet control gate is an unsealed sprinkler, and the system for battery fire extinguishing through flooding the battery further comprises:
at least one fire sensor, at least one fire sensor configured to each of the battery boxes, used for sensing a fire state to generate a fire occurrence signal;
at least one electromagnetic valve, at least one electromagnetic valve disposed outside the battery box, the electromagnetic valve connected to the water distribution pipeline, wherein the electromagnetic valve is turned on after receiving a release signal, to enable the water solution in the water distribution pipeline to flow from the water solution container to the unsealed sprinkler to fill the battery box with the water solution; and
a control host, electrically connected to the at least one fire sensor and the at least one electromagnetic valve, controlling the corresponding electromagnetic valve to interlock the water solution to fill the corresponding battery box when one of the at least one fire sensor generates the fire occurrence signal.

6. The system according to claim 5, wherein the fire sensor is selected from the group consisting of a smoke sensor, a temperature sensor, a photoelectric sensor, an infrared sensor, and a current sensor.

7. The system according to claim 5, further comprising:
a pressurizing device, connected to the control host, and controlled by the control host, to pressurize the water solution in the water solution container, so that the water solution can accelerate the filling of the corresponding battery box.

8. The system according to claim 1, further comprising:
a pressurizing device, connected to the control host, and controlled by the control host, to pressurize the water solution in the water solution container, so that the water solution can accelerate the filling of the corresponding battery box.

9. A method for battery fire extinguishing through flooding the battery, comprising the following steps of:
providing a battery box required for a battery and a water solution container, the water solution container is injected into a water solution;
detecting a fire state of the battery; and
flooding the battery in the battery box by the water solution in the water solution container to extinguish fire when the battery in the battery box is in the fire state.

10. The method according to claim 9, wherein the step of detecting the fire state of the battery is sensed performed by sensing a heat sensing mode of by a sealed automatic-sprinkler, and interlocking the water solution in the water solution container to fill the battery box.

11. The method according to claim 10, wherein the heat sensitive automatic sprinkling temperature of the sealed automatic-sprinkler is between 60° C. and 15020 C.

12. The method according to claim 9, wherein the step of detecting the fire state of the battery is performed sensed by sensing a fire sensor, and then switching an unsealed sprinkler using a control host to control an electromagnetic valve to interlock the water solution in the water solution container to fill the battery box.

13. The method according to claim 9, wherein the water solution is selected from the group consisting of tap water, sodium chloride (NaCl) solution, sodium hydroxide (NaOH) solution, and sodium sulfate (NaSO₄) solution.

14. The method according to claim 13, wherein the weight percentage of electrolyte of the sodium chloride (NaCl) solution, the sodium hydroxide (NaOH) solution, and the sodium sulfate (NaSO₄) solution ranges from 0.2% to 26%.

15. The method according to claim 9, further comprising the step of:
pressurizing the water solution in the water solution container, so that the water solution can accelerate the filling of the corresponding battery box.
